(19) United States
(12) Patent Application Publication
(10) Pub. No.: US 2009/0090833 A1
(43) Pub. Date: Apr. 9, 2009

(54) MOBILE COMMUNICATION MOUNTING DEVICE AND SYSTEM

(76) Inventor: Bernard B. Daraz, Newtown, CT (US)

Correspondence Address: LAW OFFICE OF MICHAEL A. BLAKE, LLC, 95 HIGH STREET, SUITE 5, MILFORD, CT, 06460, US

(21) Appl. No.: 11/867,761

(22) Filed: Oct. 5, 2007

(51) Int. Cl. B60R 7/05

(52) U.S. Cl. 248/316.7; 296/97.9

(57) ABSTRACT

A mounting device for a portable communication device, the mounting device comprising: a mounting base, the mounting base comprising: an attaching end located at a first end of the mounting base; a non-attaching end located at a second end of the mounting base; a centerline defined as running generally along the center the mounting base between the attaching end and the non-attaching end a smooth surface located adjacent to the attaching end and running generally along the center line of the mounting base; an attaching surface located generally collinear to the smooth surface, and adjacent to the smooth surface and adjacent to the non-attaching end; at least one clipping member rotatably attached to the mounting base, and configured to clip the mounting device to an object and allow the mounting base to rotate, upon applying a rotative force greater than a threshold amount, relative to the clipping member and the object.

### TECHNICAL FIELD

The present invention is directed generally to a device for mounting a mobile communication device, and more particularly, the present invention is directed to a device that allows for a mounting of a mobile communication device and allows for the mobile communication device to be rotated with respect to the device, and used safely in an automobile.

### BACKGROUND

Mobile communication devices, or more particularly, cellular telephones which operate by automatically selecting appropriate repeater stations depending upon the location of the telephone, have been nearly universally embraced as a convenient means of communication by many people throughout the U.S. and the world. Cell phones have become popular for discussing business or personal matters in virtually every environment, including during travel in an automobile or other motor vehicle.

However, it is widely recognized that a person using a telephone, or other mobile communication device, cannot devote his or her full attention to the telephone conversation or matter, and any other task at hand. This is particularly critical when operating heavy machinery, such as when driving an automobile or other motor vehicle. At such times, it is imperative that nearly all of one's attention be directed to the operation of the machine or vehicle, and that the operator have both hands free to operate the machine or vehicle, rather than having one hand tied up by holding a cell phone. This situation has received sufficient recognition that many jurisdictions are legislating against the use of hand held cell phones by the operator of a motor vehicle, while the vehicle is in motion.

Accordingly, various accessories have been developed to allow the hands free use of cell phones (headsets, etc.). While these devices alleviate the need to hold the telephone close to one's face while conversing on the phone, they do nothing to secure the phone to prevent its movement or temporary dislocation within the vehicle during operation of the vehicle. Many vehicle operators will place their cell phone on the adjacent seat for ease of access while driving, and use a headset for hands free phone operation. Obviously, this is not a workable solution if a passenger is occupying the seat, and in any event does nothing to prevent the phone from sliding from the seat in the event of a sudden maneuver. In fact, many accidents have been caused not solely from the distraction of a cell phone conversation, but from the vehicle driver attempting to retrieve a cell phone which has fallen.

Accordingly, a need will be seen for a cell phone holder for motor vehicles, which temporarily and removably secures a single cell phone therein for convenient access by the vehicle operator or another person in the vehicle.

### SUMMARY

The disclosed invention relates to a mounting device for a portable communication device, the mounting device comprising: a mounting base, the mounting base comprising: an attaching end located at a first end of the mounting base; a non-attaching end located at a second end of the mounting base; a centerline defined as running generally along the center the mounting base between the attaching end and the non-attaching end a smooth surface located adjacent to the attaching end and running generally along the center line of the mounting base; an attaching surface located generally collinear to the smooth surface, and adjacent to the smooth surface and adjacent to the non-attaching end; at least one clipping member rotatably attached to the mounting base, and configured to clip the mounting device to an object and allow the mounting base to rotate, upon applying a rotative force greater than a threshold amount, relative to the clipping member and the object.

The disclosed invention also relates to a cellular telephone mounting system comprising: a mounting device comprising: a mounting base, the mounting base comprising: an attaching end located at a first end of the mounting base; a non-attaching end located at a second end of the mounting base; a centerline defined as running generally along the center the mounting base between the attaching end and the non-attaching end a smooth surface located adjacent to the attaching end and running generally along the center line of the mounting base; an attaching surface located generally collinear to the smooth surface, and adjacent to the smooth surface and adjacent to the non-attaching end; at least one clipping member rotatably attached to the mounting base, and configured to clip the mounting device to an object and allow the mounting base to rotate, upon applying a rotative force greater than a threshold amount, relative to the clipping member and the object; cellular telephone with a belt clip, wherein the belt clip is removeably attachable to the mounting base at attaching surface; and wherein the mounting device is attached to a sun visor of an automobile via the at least one clipping member.

In addition, the disclosed invention also relates to a mounting device for a portable communication device, the mounting device comprising: a sun visor; at least one hinge pin rotatably attached to the sun visor; a mounting base rotatably attached the hinge pin, the mounting base comprising: an attaching end located at a first end of the mounting base; a non-attaching end located at a second end of the mounting base; a centerline defined as running generally along the center the mounting base between the attaching end and the non-attaching end a smooth surface located adjacent to the attaching end and running generally along the center line of the mounting base; an attaching surface located generally collinear to the smooth surface, and adjacent to the smooth surface and adjacent to the non-attaching end; wherein the mounting base is configured to rotate with respect to the sun visor upon applying a rotative force greater than a threshold amount, relative to the clipping member and the object.

### BRIEF DESCRIPTION OF THE FIGURES

The present disclosure will be better understood by those skilled in the pertinent art by referencing the accompanying drawings, where like elements are numbered alike in the several figures, in which:

FIG. 1 is a perspective view of the disclosed mounting device;

FIG. 2 is a perspective view of the disclosed mounting device from FIG. 1, with the clipping members rotated approximately 90°;

FIG. 3 is a perspective view of mounting base with the clipping members removed;

FIG. 4 is a perspective view of a clipping member;

FIG. 5 is a perspective view of a mounting base with a mobile communication device and belt clip;

FIG. 6 is a perspective view of the disclosed mounting device attached to a sun visor;

FIG. 7 is a perspective view of the disclosed mounting device attached to a sun visor, with the mounting base rotated approximately 90°;

FIG. 8 is a perspective view of another embodiment of the disclosed mounting device, where the clipping members snap into the mounting base;

FIG. 9 is a perspective view of the mounting base from FIG. 8; and

FIG. 10 is a perspective view of the clipping member from FIG. 8.

### DETAILED DESCRIPTION

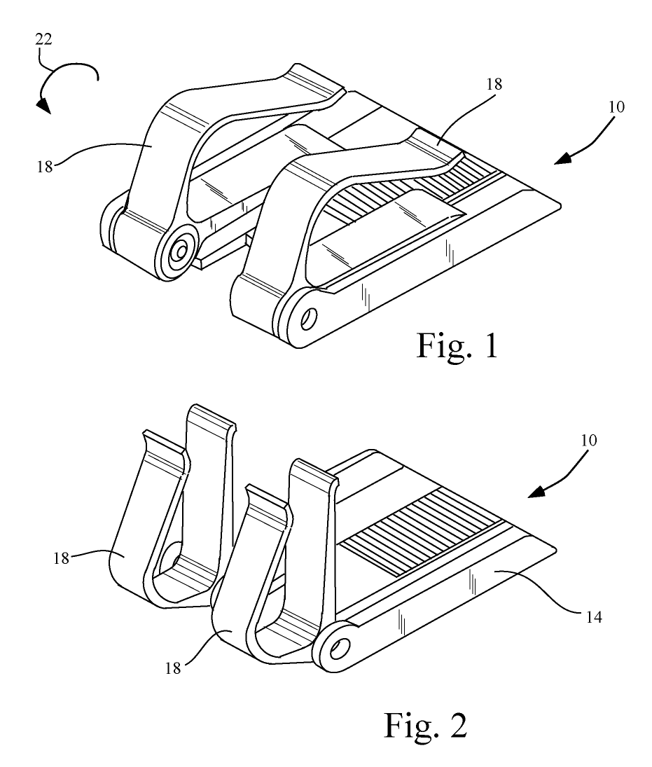

FIG. 1 shows a perspective view of the disclosed mounting device 10. The device comprises a mounting base 14 and at least one clipping member 18 rotatably attached to the mounting base 14. In this embodiment two clipping members 18 are shown, but one of ordinary skill in the art will recognize that this embodiment may be modified to use only one clipping member 18. The clipping members 18 can rotate with respect to the mounting base 14 in the direction shown by arrow 22. Of course, one can see that the mounting base 14 can rotate with respect to the clipping members 18 in a direction opposite shown by arrow 22.

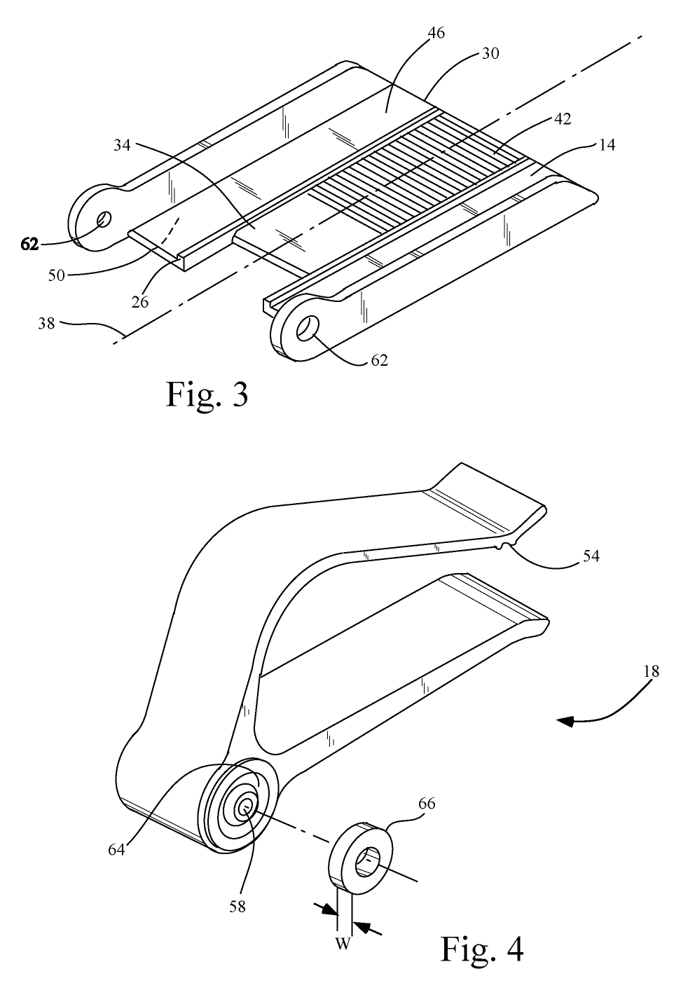

FIG. 3 shows a perspective view of the mounting base 14 with the clipping members 18 removed. The mounting base 14 has an attaching end 26 and a non-attaching end 30. Adjacent to the attaching end 26, and running generally along the center line 38 of the mounting base 14, is located a smooth surface. In this embodiment the smooth surface 34 has a generally rectangular shape. Running generally collinear with the smooth surface, and adjacent to the smooth surface 34 and the non-attaching end 30, is an attaching surface 42. The attaching surface 42 have a gripping surface on the top side 46 and the bottom side 50 of the mounting base 14. The gripping surface may include, but is not limited to: a knurled surface, a saw-tooth surface, a ridged surface, a beaded surface, a ribbed surface, or surface with a plurality of protuberances. As discussed above, the mounting base 14 is rotatably attachable to the clipping member 18. In the embodiment shown, the mounting base 14 has a screw hole 62 located near the attaching end 26 of the mounting base 14, configured to allow the clipping member to be attached to the mounting base 14 via a threaded screw.

FIG. 4 shows a perspective view of a clipping member 18. The clipping member 18 has a generally “U” shape. The clipping member 18 is configured to snugly clip onto a device such as, but not limited to an automobile's sun visor, by sliding the opening 54 of the clipping member 18 over the edge of the sun visor. The clipping member 18 is rotatably attached to the mounting base 14. In one embodiment, the clipping member 18 may be rotatably attached to the mounting base 14 via a screw that screws in a threaded screw hole 58 on the clipping member. A generally circular depression 64 is located adjacent to the threaded screw hole 58. The generally circular depression 64 is configured to allow an elastic member, such as, but not limited to an o-ring 66, to sit within it. The depression 64 is configured to only contain a portion of the o-ring's width W. The o-ring may be made out of any elastic and/or compressible material including but not limited to rubber or plastic. Thus, when the clipping member 18 is attached to the mounting base 14, the o-ring is compressed between the clipping member 18 and the mounting base 14. The o-ring provides a frictional force against rotation of the mounting base with respect to the clipping members 18, such that when the mounting base is rotated relative to the clipping member 18, the mounting generally remains in its angular position. However, any other known means of allowing a member to rotate with respect to another member to a particular angular position, with the angular position generally held after the rotation will be included in this disclosure. Thus, it should be clear to one of ordinary skill in the art, that the mounting base can rotate relative to the clipping members 18 when a rotative force greater than a threshold amount is applied to the mounting base 14. Thus, the mounting base 14 will not freely rotate/swing with respect to the clipping member 18, but will hold its rotative position, until a rotative force greater than a minimum threshold amount is applied to the mounting base 14.

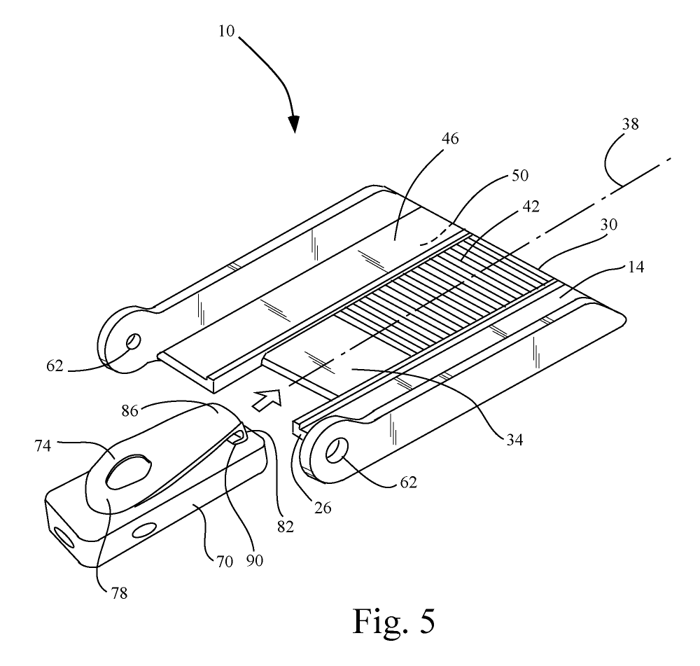

FIG. 5 shows how a mobile communication device 70 can attach to the mounting device 10. In this Figure, the clipping members 18 are removed for clarity. The mobile communication device will have a belt clip 74, or some other clip mechanism to hold the device to a person's belt, pocket, briefcase, etc. The belt clip 74 typically is spring loaded and operates by squeezing a first end 78 of the belt clip, to open the jaw 82 at second end 86. The jaw 82 may have a generally u-shaped member 90, which normally securely holds the belt clip to a user's belt. In order to mount the mobile communication device 70 with the belt clip 74 onto the mounting device 10, one opens the jaw 82, and slides the second end 86 over attaching end 26 and over the smooth surface 34 of the mounting base 14, and onto the attaching surface 42, where the jaw 82 is allowed to close. Because the attaching surface 42 is knurled or has a saw tooth profile, or other beaded or ridged surface, the clip 70 will firmly attach to the mounting base. The attaching end 26 is designated the “attaching” end because this is the end of the mounting base 14 that the mobile communication device 70 will slide over in order to attach to the mounting base 14. The non-attaching end 30 is at an opposite end of the mounting base 14.

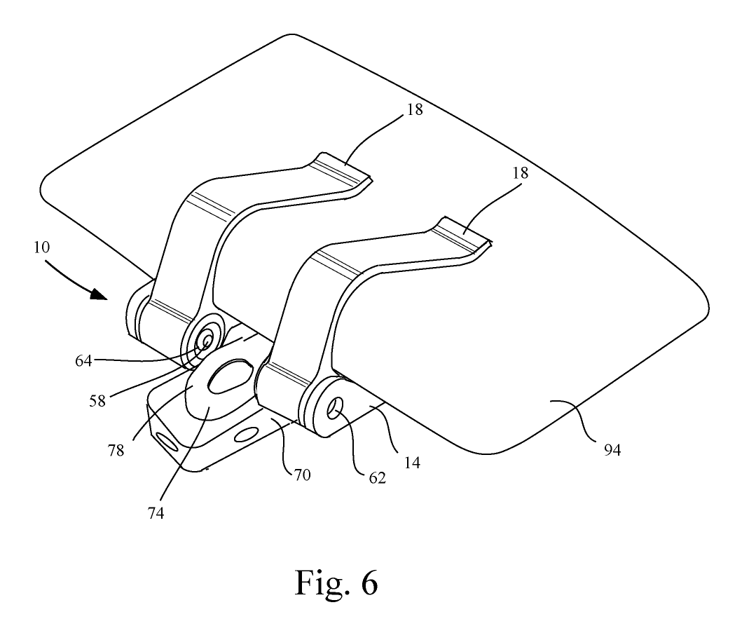

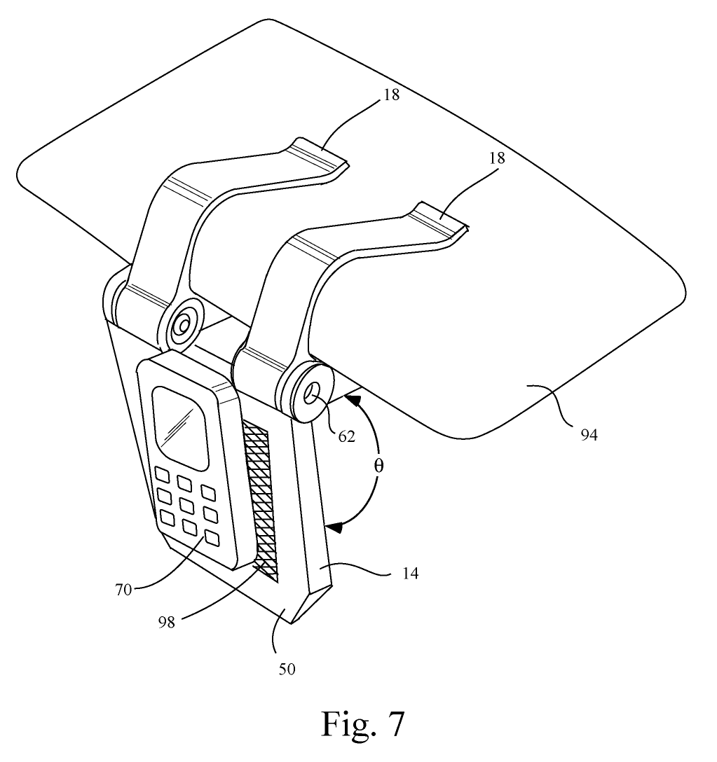

FIG. 6 shows how the mounting device 10 can attach to a sun visor 94 of an automobile. The clipping members 18 hold the mounting device 70 securely to the sun visor. FIG. 7 shows how the mounting base 14 can rotate relative to the clipping members 18 and the sun visor 94. The mounting base is shown having an angle θ with respect to the clipping members 18 and sun visor. In FIG. 7, θ is approximately 90°. However, the mounting base 14 is rotatable between angles from about θ to about 180°, or more. The bottom side 50 of the mounting base 14 may have a slide reducing surface 98. The slide reducing surface 98 may comprise rubber, sandpaper, sandpaper like material, textured plastic, resilient plastic, or other resilient or tacky material. In FIG. 6, θ is at about θ degrees.

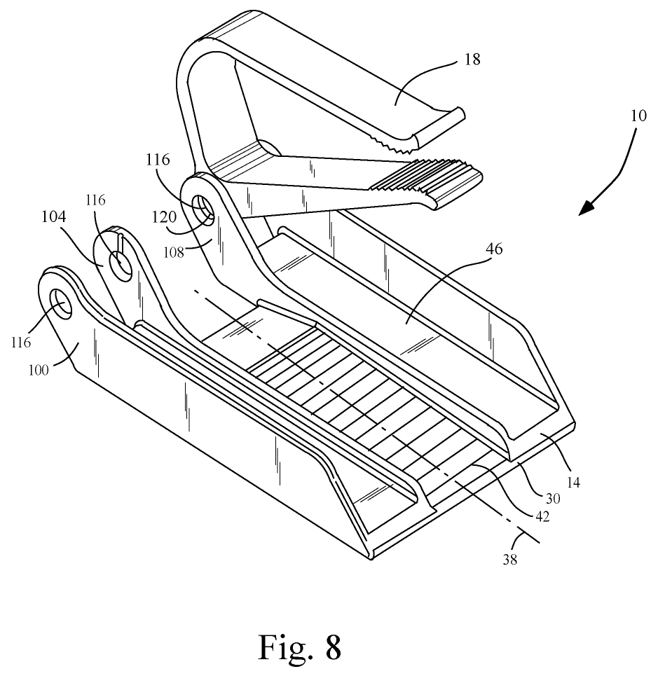

FIG. 8 shows another embodiment of the disclosed mounting device 10. In this embodiment, rather than using screws and screw holes to attach the clipping members 18 to the mounting base 14, the mounting base comprises four extended members 100, 104, 108, and 112. Two of the clipping members are on one side of the centerline 38, and the other two clipping members are on another side of the centerline 38. Each extended member 100, 104, 108, 112 has an opening 116. A clipping member 18 (only one clipping member 18 is shown in this figure for clarity) can snap in between two adjacent extended members, as shown with extending members 108 and 112. The clipping member has two protrusions 120, 124, that are configured to fit within the openings 116. The clipping members may snap in between two adjacent extending members with an interference fit, which will provide enough friction and holding force, to allow one to rotate the mounting base 14 with respect to the clipping members 18, and the rotative orientation will hold in place, even with a mobile communication device 70 and belt clip 74 attached to the mounting base 14. In another embodiment, each clipping member 18 may have one or more key protrusions that may correspond with one or more grooves located on the extending members, such that as the mounting member 14 rotates with respect to the clipping members 18, the protrusions may lock into place in a correspond groove, in order to assist in holding the rotated position of the mounting base 14 with respect to the clipping members 18. It should be noted that the clipping member 18 in this Figure is different than the clipping member 18 in FIGS. 1-7.

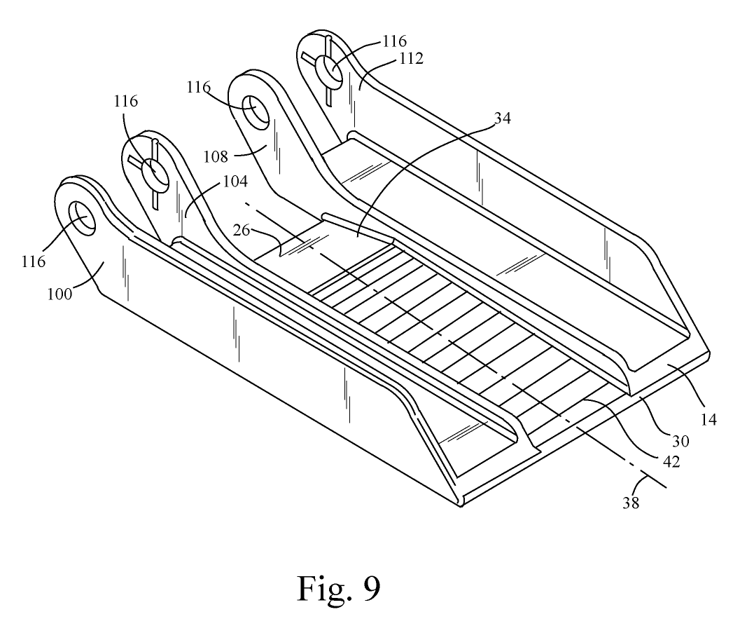

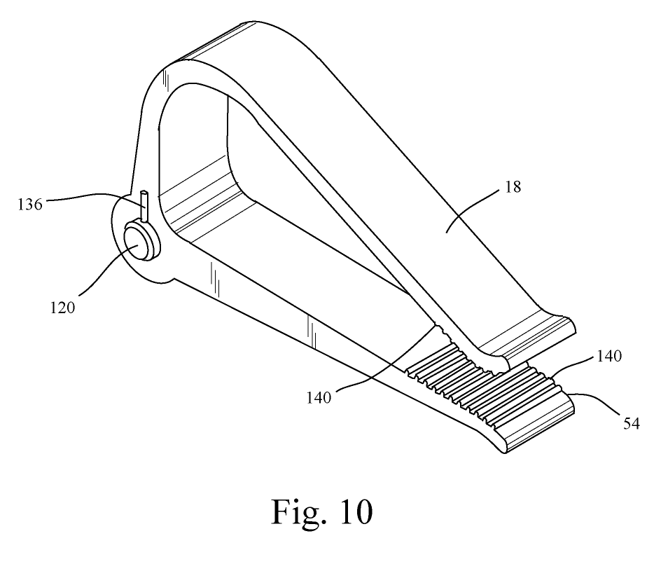

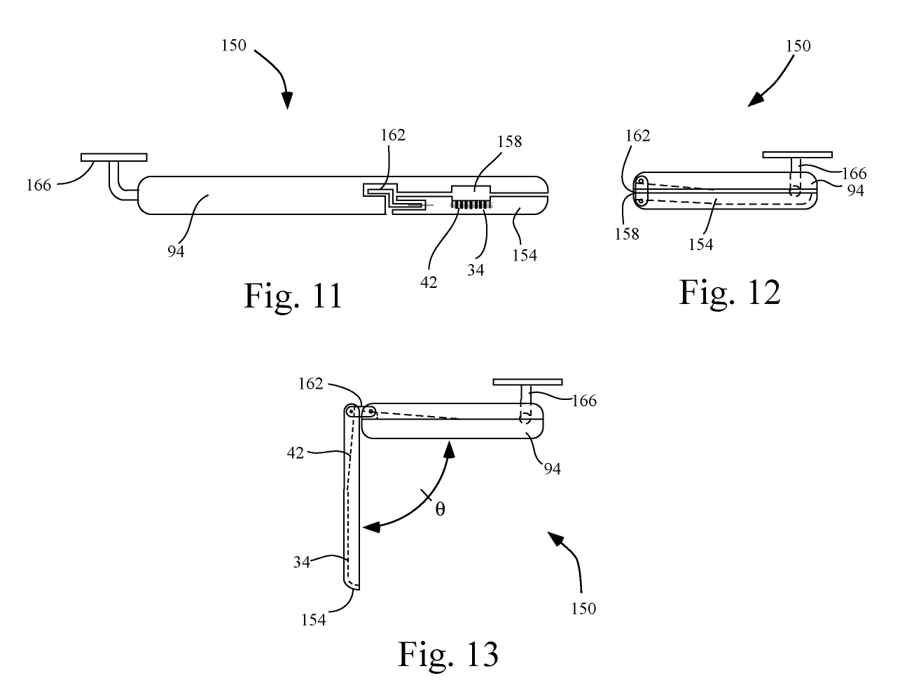

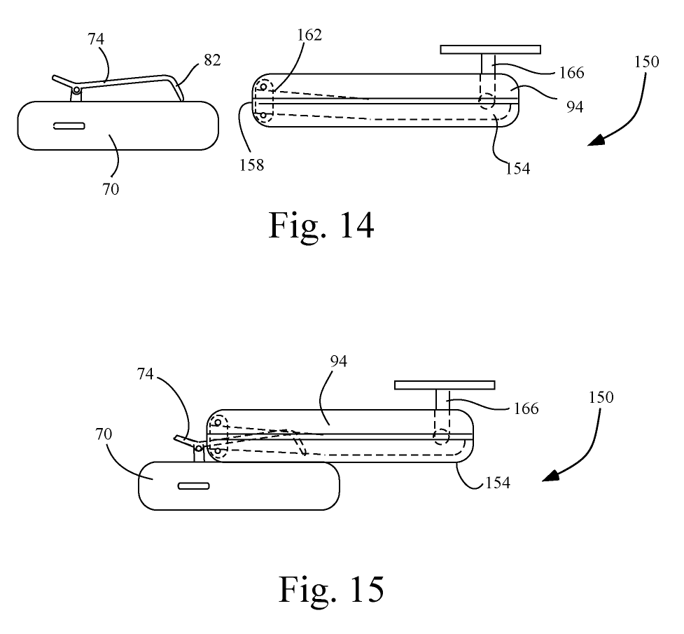

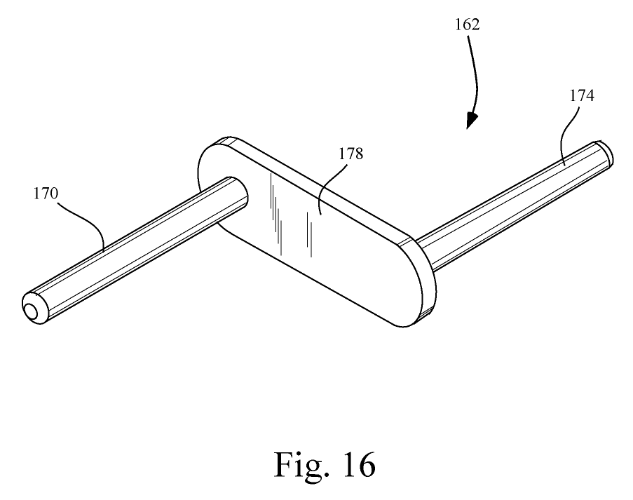

FIG. 9 shows a detailed view of a mounting base 14 from FIG. 8. In this view the grooves 128 on the extending members 104, and 112 are shown. FIG. 10 shows a detailed view of a clipping member 18 from FIG. 8. In this view, the protrusion 132 on the clipping member is visible as is the keyed protrusion 136. Also detailed in this view are ribs 140 located adjacent to the clipping member opening 54. The ribs 140 will assist in holding the mounting device 10 onto the visor 94, or other device.

FIG. 11 shows another embodiment of the disclosed mounting device 150. In this embodiment, the mounting device 150 is integral with a sun visor 94. The sun visor 94 attaches to the roof of a vehicle via a known sun visor attaching device 166. A mounting base 154 comprises a portion of the sun visor 94. A visor opening 158 is defined by a recess in the sun visor 94 and mounting base 154. The visor opening 158 is configured to allow the jaw 82 of a belt clip 74 for a mobile communication device 70 to slide in over a smooth surface 34 and attach to the attaching surface 42 of the mounting base 154. A hinge pin 162 allows the mounting base 154 to rotate out from the sun visor 94 (as will be shown in subsequent figures). FIG. 12 shows a side view of the disclosed mounting device 150. FIG. 13 shows the mounting device 150 with the mounting base 154 rotated from the sun visor 94 such that the angle θ (the angle between the mounting base 154 and the sun visor 94) is about 88°. The hinge pin 162 has a very tight fit with the mounting base 154 and sun visor 94, such that the mounting base 154 will hold its rotative position. In some embodiments, the hinge pin 162 may have an interference fit with the mounting base 154 and sun visor 94, in other embodiments, the hinge pin 162 may comprise a saw tooth type surface that clicks into position with respect to the mounting base 154 and sun visor 94. FIG. 14 shows a side view again of the disclosed mounting device 150 with a mobile communication device 70 with belt clip 74 about to be attached to the mounting base 154. FIG. 15 shows the side view of the mounting device 150 with the mobile communication device 70 attached to the mounting base 154. FIG. 16 shows a perspective close up view of the hinge pin 162. The hinge pin 162 comprises a first pin member 170 and a second pin member 174 attached to a pin base 178. The first and second pin member 170, 174 are parallel to each other, and the pin base 178 is orthogonal to both the first and second pin members 170, 174.

The disclosed invention has many advantages. The mounting device allows one to mount his mobile communication device in an out of the way, but easily accessible area in an automobile. The rotatability of the mounting base allows one to easily read any information displayed on the mobile communication device, and/or use a speaker phone on the mobile communication device. The mounting base can be rotated so that it is up against the sun visor and out of the way for driving. The mobile communication device and belt clip can be removed from one's belt and attached to the mounting device that is already installed on a sun visor. Similarly, the mobile communication device and belt clip can be removed from the mounting device, while leaving the mounting device on the sun visor. When using the mounting device with a cellular phone in a speaker phone mode, one avoids violating many ordinances against driving while using a cellular phone. Safety is increased when using the mounting device, because one does not have to look down at his communication device, but rather only needs to glance up towards his sun visor to look at his communication device. The disclosed invention may be modified and custom molded so that a mobile communication device will not need a belt clip to attach to the mounting device 10, but rather would snap directly into a custom molded mounting base 14.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A mounting device for a portable communication device, the mounting device comprising:
a mounting base, the mounting base comprising:
an attaching end located at a first end of the mounting base;
a non-attaching end located at a second end of the mounting base;
a centerline defined as running generally along the center the mounting base between the attaching end and the non-attaching end
a smooth surface located adjacent to the attaching end and running generally along the center line of the mounting base;
an attaching surface located generally collinear to the smooth surface, and adjacent to the smooth surface and adjacent to the non-attaching end;
at least one clipping member rotatably attached to the mounting base, and configured to clip the mounting device to an object and allow the mounting base to rotate, upon applying a rotative force greater than a threshold amount, relative to the clipping member and the object.

2. The mounting device of claim 1, wherein the attaching surface has a surface to assist in attachment consisting of a knurled surface, a saw tooth surface, a beaded surface, a ribbed surface and a ridged surface.

3. The mounting device of claim 1, wherein the at least one clipping member further comprises:
a clipping screw hole located on an axis of rotation of the at least one clipping member;
a generally circular depression located on the at least one clipping member adjacent to the screw hole;
wherein the mounting base further comprises a base screw hole located about the axis of rotation of the mounting base; and
wherein the mounting device further comprises:
an elastic member located in the generally circular depression and between the at least one clipping member and the mounting base;
a screw configured to attach the mounting base to the at least one clipping member, via the clipping screw hole and the base screw hole.

4. The mounting device of claim 3, wherein the elastic member is an o-ring.

5. The mounting device of claim 3, wherein the elastic member is made out of a material selected from the group consisting of rubber, and plastic.

6. The mounting device of claim 1, wherein the mounting base comprises:
a first extended member, with a hole located on the first extended member adjacent to the attaching end, the first extended member located on a first side of the centerline;
a second extended member, with a hole located on the second extended member adjacent to the attaching end, the second extended member located on a first side of the centerline, the second extended member located adjacent to the first extended member, and forming a first pair of extending members with the first extended member;
a third extended member, with a hole located on the third extended member adjacent to the attaching end, the third extended member located on a second side of the centerline;
a fourth extended member, with a hole located on the fourth extended member adjacent to the attaching end, the fourth extended member located on a second side of the centerline, the fourth extended member located adjacent to the third extended member, and forming a second pair of extending members with the first extended member;
a first clipping member, wherein the first clipping member comprises:
a pair of protrusions, wherein each protrusion is configured to rotatably fit within one of the pair of holes in the first pair of extended members;
a second clipping member, wherein the second clipping member comprises:
a pair of protrusions, wherein each protrusion is configured to rotatably fit within one of the pair of holes in the second pair of extended members.

7. The mounting device of claim 6, further comprising:
a pair of keyed protrusion, each keyed protrusion located adjacent to one of the pair of protrusions on the clipping member;
a grove located on each extended member, and configured to receive a keyed protrusion from the clipping member to assist in holding the rotative position of the mounting base with respect to the clipping member.

8. A cellular telephone mounting system comprising:
a mounting device comprising:
a mounting base, the mounting base comprising:
an attaching end located at a first end of the mounting base;
a non-attaching end located at a second end of the mounting base;
a centerline defined as running generally along the center the mounting base between the attaching end and the non-attaching end
a smooth surface located adjacent to the attaching end and running generally along the center line of the mounting base;
an attaching surface located generally collinear to the smooth surface, and adjacent to the smooth surface and adjacent to the non-attaching end;
at least one clipping member rotatably attached to the mounting base, and configured to clip the mounting device to an object and allow the mounting base to rotate, upon applying a rotative force greater than a threshold amount, relative to the clipping member and the object;
a cellular telephone with a belt clip, wherein the belt clip is removeably attachable to the mounting base at attaching surface; and
wherein the mounting device is attached to a sun visor of an automobile via the at least one clipping member.

9. The cellular telephone mounting system of claim 8, wherein the attaching surface has a surface to assist in attachment consisting of a knurled surface, a saw tooth surface, a beaded surface, a ribbed surface and a ridged surface.

10. The cellular telephone mounting system of claim 8, wherein the at least one clipping member further comprises:
a clipping screw hole located on an axis of rotation of the at least one clipping member;
a generally circular depression located on the at least one clipping member adjacent to the screw hole;
wherein the mounting base further comprises a base screw hole located about the axis of rotation of the mounting base; and
wherein the mounting device further comprises:
an elastic member located in the generally circular depression and between the at least one clipping member and the mounting base;
a screw configured to attach the mounting base to the at least one clipping member, via the clipping screw hole and the base screw hole.

11. The cellular telephone mounting system of claim 10, wherein the elastic member is an o-ring.

12. The cellular telephone mounting system of claim 10, wherein the elastic member is made out of a material selected from the group consisting of rubber, and plastic.

13. The cellular telephone mounting system of claim 8, wherein the mounting base comprises:
a first extended member, with a hole located on the first extended member adjacent to the attaching end, the first extended member located on a first side of the centerline;
a second extended member, with a hole located on the second extended member adjacent to the attaching end, the second extended member located on a first side of the centerline, the second extended member located adjacent to the first extended member, and forming a first pair of extending members with the first extended member;
a third extended member, with a hole located on the third extended member adjacent to the attaching end, the third extended member located on a second side of the centerline;
a fourth extended member, with a hole located on the fourth extended member adjacent to the attaching end, the fourth extended member located on a second side of the centerline, the fourth extended member located adjacent to the third extended member, and forming a second pair of extending members with the first extended member;
a first clipping member, wherein the first clipping member comprises:
a pair of protrusions, wherein each protrusion is configured to rotatably fit within one of the pair of holes in the first pair of extended members;
a second clipping member, wherein the second clipping member comprises:
a pair of protrusions, wherein each protrusion is configured to rotatably fit within one of the pair of holes in the second pair of extended members.

14. The cellular telephone mounting system of claim 13, further comprising:
a pair of keyed protrusion, each keyed protrusion located adjacent to one of the pair of protrusions on the clipping member;
a grove located on each extended member, and configured to receive a keyed protrusion from the clipping member to assist in holding the rotative position of the mounting base with respect to the clipping member.

15. A mounting device for a portable communication device, the mounting device comprising:
a sun visor;
a hinge pin rotatably attached to the sun visor;
a mounting base rotatably attached the hinge pin, the mounting base comprising:
an attaching end located at a first end of the mounting base;
a non-attaching end located at a second end of the mounting base;
a centerline defined as running generally along the center the mounting base between the attaching end and the non-attaching end
a smooth surface located adjacent to the attaching end and running generally along the center line of the mounting base;
an attaching surface located generally collinear to the smooth surface, and adjacent to the smooth surface and adjacent to the non-attaching end;
wherein the mounting base is configured to rotate with respect to the sun visor upon applying a rotative force greater than a threshold amount, relative to the clipping member and the object.

16. The mounting device of claim 15, wherein the hinge pin comprises:
a first pin member
a pin base fixedly attached to the first pin member;
a second pin member fixedly attached to the pin base; and
wherein the first and second pin members are parallel to each other, and the pin base is orthogonal to both the first and second pin members.
